(19) United States
(12) Patent Application Publication
(10) Pub. No.: US 2004/0095869 A1
(43) Pub. Date: May 20, 2004

(54) Optical pickup device and method and apparatus for assembling the same

(75) Inventor: Akiho Yoshizawa, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 10/696,849

(22) Filed: Oct. 29, 2003

(30) Foreign Application Priority Data
Nov. 15, 2002 (JP) 2002-332458

(51) Int. Cl. G11B 7/135

(52) U.S. Cl. 369/112.16; 369/112.29

(57) ABSTRACT

The present invention provides an optical pickup device comprises at least:

a housing; and

a beam splitter fixed to a beam splitter attachment position of the housing by an adhesive so that a splitter optical axis matches a design optical axis,

wherein the housing has a temporary positioning projection for temporarily positioning the beam splitter in/around the beam splitter attachment position by abutting the beam splitter, and in the beam splitter attachment position, a plurality of through holes for inserting therein a plurality of projection sticks which are movable toward/apart from an attachment surface of the beam splitter while the beam splitter is abutting the temporarily positioning projection and the adhesive is uncured.

### CROSS-REFERENCE TO RELATED APPLICATION

This application is related to Japanese application No. 2002-332458 filed on Nov. 15, 2002, whose priority is claimed under 35 USC §119, the disclosure of which is incorporated by reference in its entirety.

### BACKGROUND OF THE INVENTION

1. Field of the Invention

The present invention relates to an optical pickup device and a method and apparatus for assembling an optical pickup device. More particularly, the invention relates to an optical pickup device capable of reproducing, erasing, or recording information of an information recording medium such as an optical disk or a magneto-optical disk and to a method and apparatus for assembling an optical pickup device.

2. Description of the Background Art

Hitherto, an optical pickup device having a laser beam source, a beam splitter, a collimator lens, a diffraction mirror, a condenser lens (objective lens), a photodetector, and a housing for housing those optical parts is known (refer to, for example, Japanese Unexamined Patent Publication No. 2000-251310). A laser beam emitted from the laser beam source of the optical pickup device passes through the beam splitter and becomes parallel light by the collimator lens. The parallel light is diffracted by the diffraction mirror and is made focus light by the condenser lens. The focus light is condensed to become a small spot on an optical disk. Reflection light from the optical disk becomes again parallel light by the condenser lens and is diffracted by the diffraction mirror. The light passes through the collimator lens and is reflected by a reflection surface of the beam splitter, and the reflection light enters the photodetector. On the basis of a signal detected by the photodetector, information is recorded, reproduced, or the like.

FIGS. 13 to 15 show a structure of mounting the beam splitter of the conventional optical pickup device as described above to the housing. FIG. 13 is a partially sectional side view of the conventional optical pickup device. FIG. 14 is an enlarged sectional view of a main portion showing a beam splitter in the conventional optical pickup device. FIG. 15 is a plan view of a main portion showing the beam splitter in the conventional optical pickup device.

A housing 100 includes, in a parts attachment position of an optical parts attachment surface (bottom surface) 111, are three positioning projections 113 each having a contact surface which comes into contact with a side surface of a beam splitter 3, and are three supporting projections 114 each having a contact surface which comes into contact with the undersurface of the beam splitter 3. The posture of the beam splitter 3 is determined by the contact with the three positioning projections 113 and the three supporting projections 114. In this state, the beam splitter 3 is adhered with an adhesive S₁. The adhesion precision of the beam splitter 3 is managed by finishing precision of the three positioning projections 113 and the three supporting projections 114. Therefore, only by fixing the beam splitter 3 to the parts attachment position, the splitter optical axis angle of the beam splitter 3 in a swing direction parallel to the optical parts attachment surface 111 of the housing 100 can be maintained at a precision of ±5 arcminutes from a target design optical axis by the three positioning projections 113. The splitter optical axis angle of the beam splitter 3 in a swing direction toward/apart from the optical parts attachment surface 111 of the housing 100 can be maintained at a precision of ±10 arcminutes from a target design optical axis by the three supporting projections 114. After the positioning, the beam splitter 3 can be fixed by the adhesive S₁.

As shown in FIG. 15, however, at the time of mounting the beam splitter 3 on the optical parts attachment surface 111 of the housing 100 via the adhesive S₁, the adhesive S₁ is spread by the beam splitter 3. Since the shape of the spread adhesive S₁ is not uniform, there is a problem such that adhesion force (adhesion strength) for fixing the beam splitter 3 is unstable.

The pickup device is requested to be miniaturized and to be adapted to writing to a DVD (Digital Versatile Disk). Consequently, the splitter optical axis angle of the beam splitter 3 in the swing direction toward/apart from the optical parts attachment surface 111 of the housing 100 has to be suppressed within ±5 arcminutes from the target design optical axis. However, due to a finishing error of the contact surfaces of the three supporting projections 114 of the beam splitter 3, it is difficult to manage the splitter optical axis angle to be within ±5 arcminutes as a target. There is a problem such that the beam splitter optical axis angle cannot be adjusted with high precision.

### SUMMARY OF THE INVENTION

One of main objects of the invention is therefore to provide an optical pickup device capable of adjusting a beam splitter optical axis angle with respect to a design optical axis at high precision, and a method and apparatus for assembling the optical pickup device.

To achieve the object, an optical pickup device of the invention comprises at least:

a housing; and

a beam splitter fixed to a beam splitter attachment position of the housing by an adhesive so that a splitter optical axis matches a design optical axis,

wherein the housing has a temporary positioning projection for temporarily positioning the beam splitter in/around the beam splitter attachment position by abutting the beam splitter, and in the beam splitter attachment position, a plurality of through holes for inserting therein a plurality of projection sticks which are movable toward/apart from an attachment surface of the beam splitter while the beam splitter is abutting the temporarily positioning projection and the adhesive is uncured.

Specifically, in the optical pickup device of the invention, the beam splitter can be temporarily positioned in the beam splitter attachment position of the housing by using the contact surface of the temporary positioning projection, the plurality of through holes are formed in the beam splitter attachment position of the housing, and projection sticks of an assembling apparatus to be described later can be inserted into the through holes. At the time of assembling the optical pickup device, therefore, in a state where the adhesive is uncured, the projection sticks are individually displaced relative to the attachment surface of the beam splitter, thereby enabling the space between the beam splitter and the optical parts attachment surface of the housing and the angle of the attachment surface of the beam splitter to be adjusted at high precision. As a result, the angle of displacement between the splitter optical axis of the beam splitter and a target design optical axis can be held at high precision (within ±5 arcminutes) in the swing direction parallel to the optical parts attachment surface of the housing. In addition, the angle of displacement between the splitter optical axis of the beam splitter between the target design optical axis can be held at high precision (within ±5 arcminutes) in the swing direction perpendicular to the optical parts attachment surface of the housing. In the position, the beam splitter can be fixed by an adhesive. In such a manner, the high-precision optical pickup device can be obtained.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a plan view showing an optical pickup device of a first embodiment of the invention.

FIG. 2 is a partially sectional side view showing the optical pickup device of the first embodiment.

FIG. 3 is a plan view of a housing in the first embodiment.

FIG. 4 is a partially cross sectional side view showing the housing in the first embodiment.

FIG. 5 is an enlarged plan view of a main portion showing a beam splitter attachment position in the housing in the first embodiment.

FIG. 6 is a side view showing the body of the apparatus for assembling the optical pickup device in the first embodiment and shows a state where the beam splitter is being attached to the housing.

FIG. 7 is a plan view showing the body of the apparatus for assembling the optical pickup device in the first embodiment and shows a state where the beam splitter is being attached to the housing.

FIG. 8 is a plan view of a main portion showing a state where the beam splitter is pressed against the adhesive in the first embodiment.

FIG. 9 is a sectional view of a main portion showing a state where the angle of an attachment surface of the beam splitter is being adjusted by projection sticks of the assembling apparatus in the first embodiment.

FIG. 10 is illustrating another structure of the apparatus for assembling the optical pickup device and assembling method.

FIG. 11 is illustrating the apparatus for assembling the optical pickup device and assembling method.

FIG. 12 is a plan view showing a state where the beam splitter is temporarily positioned in the housing of the optical pickup device in a third embodiment.

FIG. 13 is a partially sectional side view of the conventional optical pickup device.

FIG. 14 is an enlarged sectional view of a main portion showing a beam splitter in the conventional optical pickup device.

FIG. 15 is a plan view of a main portion showing the beam splitter in the conventional optical pickup device.

### DESCRIPTION OF THE PREFERRED EMBODIMENTS

In the invention, the swing direction parallel to the optical parts attachment surface of the housing is defined as a rotational direction of an imaginary axis perpendicular to the optical parts attachment surface of the housing and passing an almost center of the beam splitter. The swing direction toward/apart from the optical parts attachment surface of the housing is defined as a rotational direction of an imaginary axis parallel to the optical parts attachment surface of the housing and passing an almost center of the beam splitter.

Examples of an information recording medium to which the optical pickup device of the invention is used are optical disks such as LD, CD, CD-ROM, DVD-ROM, CD-R, DVD-R, CD-RW, DVD-RW, DVD+R, DVD+RW, and DVD-RAM and magneto-optical disks such as MO and MD. Particularly, the optical pickup device of the invention can be suitably used for writable DVD-R, DVD-RW, DVD+R, DVD+RW, DVD-RAM, and the like requiring high attachment precision of an optical part.

In the invention, the housing may have, in its beam splitter attachment position, an adhesive housing recess for housing an adhesive and a reserve recess which is communicated with the adhesive housing recess for receiving an uncured adhesive overflowed from the housing recess by being pressed by the beam splitter.

With the configuration, at the time of assembly, when a predetermined amount of the adhesive is applied on the adhesive housing recess and the beam splitter is put on the adhesive, the adhesive is pressed by the attachment surface (undersurface) of the beam splitter, and an excessive adhesive flows in the reserve recesses. Consequently, the beam splitter can be adhered to the optical parts attachment surface of the housing by the adhesive spread in the shape which is almost the same as the shape of the adhesive housing recess. Since the application area of the adhesive can be set as described above, the adhesive strength of the beam splitter is maintained uniform and the positioning quality is stabilized. In addition, the adhesive is not wasted so that the cost can be reduced. As an adhesive, an adhesive which is cured with a some margin in time or a photo-curing adhesive can be used.

In the invention, the adhesive housing recess may be disposed almost in the center of the beam splitter attachment position of the housing, and the through holes may be disposed around the adhesive housing recess.

In such a manner, at the time of assembling the optical pickup device, the angle of the attachment surface of the beam splitter can be easily adjusted by a projection stick. Since the adhesive is cured in almost center of the attachment surface of the beam splitter, the adhesive strength to the beam splitter is uniform.

Further, the through holes comprise three through holes provided in positions of three vertexes of an almost equilateral triangle around the adhesive housing recess in the beam splitter attachment position of the housing. Alternatively, the through holes comprise two through holes provided in positions of two vertexes of an almost equilateral triangle around the adhesive housing recess in the beam splitter attachment position of the housing, and a projection for supporting the attachment surface of the beam splitter is provided in a position of the remaining one vertex of the equilateral triangle. These arrangements will be described in detail later in Description of Preferred Embodiments of the Invention.

In the invention, a plurality of optical parts attached to the optical parts attachment surface of the housing of the optical pickup device are, other than the beam splitter, one or two laser beam sources, a collimator lens, a diffraction mirror, an objective lens, one or two photodetectors, and the like.

According to another aspect of the invention, there are provided methods of assembling the optical pickup device; (1) an assembling method of the device when the beam splitter is assembled to the housing before, the diffraction mirror is assembled, and (2) an assembling method of the device when the diffraction mirror is assembled in the before, the beam splitter is assembled.

The method (1) of assembling an optical pickup device comprises the steps of:

(A) applying an adhesive to a beam splitter attachment position of a housing;

(B) mounting the beam splitter in a temporarily positioned state at the beam splitter attachment position via the adhesive; and

(C1) adjusting an angle of the attachment surface of the beam splitter in a state where the adhesive is uncured,

wherein in the step (C1), the angle of the attachment surface of the beam splitter is adjusted so that a beam splitter optical axis matches a design optical axis by inserting projection sticks in through holes formed in the beam splitter attachment position of the housing and moving each of the projection sticks toward/apart from the attachment surface while detecting light projected to the beam splitter and reflected by a reflection surface of the beam splitter.

In other words, light is emitted from the light source to the beam splitter, and reflection light reflected by the reflection surface of the beam splitter is detected by a photodetector. While seeing a screen display such as a monitor, the user adjusts the angle of the attachment surface of the beam splitter so that the beam splitter optical axis matches the design optical axis. Therefore, the attachment position of the beam splitter can be easily adjusted.

On the other hand, the method (2) of assembling an optical pickup device comprises the steps of:

(A) applying an adhesive to a beam splitter attachment position of a housing;

(B) mounting a beam splitter in a temporary positioned state at the beam splitter attachment position via the adhesive; and

(C2) adjusting an angle of the attachment surface of the beam splitter in a state where the adhesive is uncured.

wherein in the step (C2), the angle of the attachment surface of the beam splitter is adjusted so that a beam splitter optical axis matches a design optical axis by inserting projection sticks in through holes formed in the beam splitter attachment position of the housing and moving each of the projection sticks toward/apart from the attachment surface while allowing light projected to and reflected from a diffraction mirror to enter the beam splitter, allowing the light reflected by a reflection surface of the beam splitter to be emitted to a reflection mirror, allowing backlight reflected by the reflection mirror to be reflected by the beam splitter, allowing the light reflected by the beam splitter to be reflected by the diffraction mirror and detecting the light reflected by the diffraction mirror.

According to this assembling method, the assembling step of assembling the diffraction mirror to the housing before assembling the beam splitter can be employed. By performing a position adjustment of the beam splitter with respect to the position of the diffraction mirror at the time of assembling the beam splitter, the subsequent positional adjustment of the diffraction mirror can be simplified.

In the methods (1) and (2), a predetermined amount of displacement of the beam splitter optical axis with respect to the design optical axis is acceptable. The design optical axis of the device is determined by an optical axis of a prototype with a beam splitter.

According to further another aspect of the invention, an optical pickup device assembling apparatus for the method (1) and an optical pickup device assembling apparatus for the method (2) are provided.

An apparatus for assembling the optical pickup device in the case of (1) comprises:

a supporting part for supporting a housing;

a projector for projecting light to a beam splitter which is mounted in a temporary positioned state at a beam splitter attachment position of the housing via an adhesive;

a reflected light detector for detecting light projected from the projector and reflected by a reflection surface of the beam splitter; and

a beam splitter angle adjusting unit for adjusting the angle of an attachment surface of the beam splitter in a state where the adhesive is uncured,

wherein the beam splitter angle adjusting unit has projection sticks inserted in through holes formed in the beam splitter attachment position of the housing and move toward/apart from the attachment surface of the beam splitter, for adjusting the angle of the attachment surface so that a beam splitter optical axis matches a design optical axis.

The supporting part is not particularly limited as long as it has a supporting structure, for example, for lifting the under face (attachment surface) by holding the peripheral portion of the housing.

As the projector, the same semiconductor laser as that used in the optical pickup device is used.

As the reflection light detector, a photosensitive device such as a CCD camera or a photo-diode array is used so that an image can be seen on an image display such as a CRT monitor, a liquid crystal monitor, or the like.

The beam splitter angle adjusting unit may be constructed by an plurality projection sticks each having a rounded tip, and a displacing mechanism for displacing each of the projection sticks in the directions of projection and contraction while holding the projection sticks. The displacing mechanism has, for example, a plurality of horizontal arm portions for holding the projection sticks vertically, an inner support for supporting the horizontal arm portions, a cylindrical outer guide support for holding the inner support so as to be movable in the vertical direction, an adjusting knob, a holding part for rotatably holding the adjusting knob, a pinion member fixed at an inner end of the adjusting knob penetrating a side wall of the outer guide support, and a rack member provided on the side surface of the inner support along its longitudinal direction which meshes with the pinion member. By turning the adjusting knob, the inner support and the horizontal arm portion are moved slightly in the vertical direction so that the projection sticks are slightly moved in the vertical direction.

The beam splitter angle adjusting unit is small and is easily operated, and maintenance thereof is also easy.

An apparatus for assembling the optical pickup device in the case of (2) comprises:

a supporting unit for supporting a housing;

a projector for projecting light via a diffraction mirror to a beam splitter mounted in a temporary positioned state at a beam splitter attachment position of the housing via an adhesive;

a reflection mirror for reflecting toward the beam splitter light projected from the projector, diffracted by the diffraction mirror, incident on the beam splitter and reflected by a reflection surface of the beam splitter;

a backlight detector provided integrally with the projector for detecting backlight transmitted from the reflection mirror via the beam splitter and the diffraction mirror; and

a beam splitter angle adjusting unit for adjusting the angle of an attachment surface of the beam splitter in a state where the adhesive is uncured,

wherein the beam splitter angle adjusting unit has projection sticks inserted in through holes formed in the beam splitter attachment position of the housing and move toward/apart from the attachment surface of the beam splitter, for adjusting the angle of the attachment surface so that a beam splitter optical axis matches a design optical axis.

In this case, the supporting unit and the beam angle adjusting unit can be constructed in a manner similar to those in the apparatus (1). As the projector and the backlight detector, a unit in which a light emitting part, a light receiving part, and optical parts are integrated can be used.

Embodiments of the invention will be described in detail hereinbelow with reference to the drawings. However, the invention is not limited to the embodiments.

First Embodiment

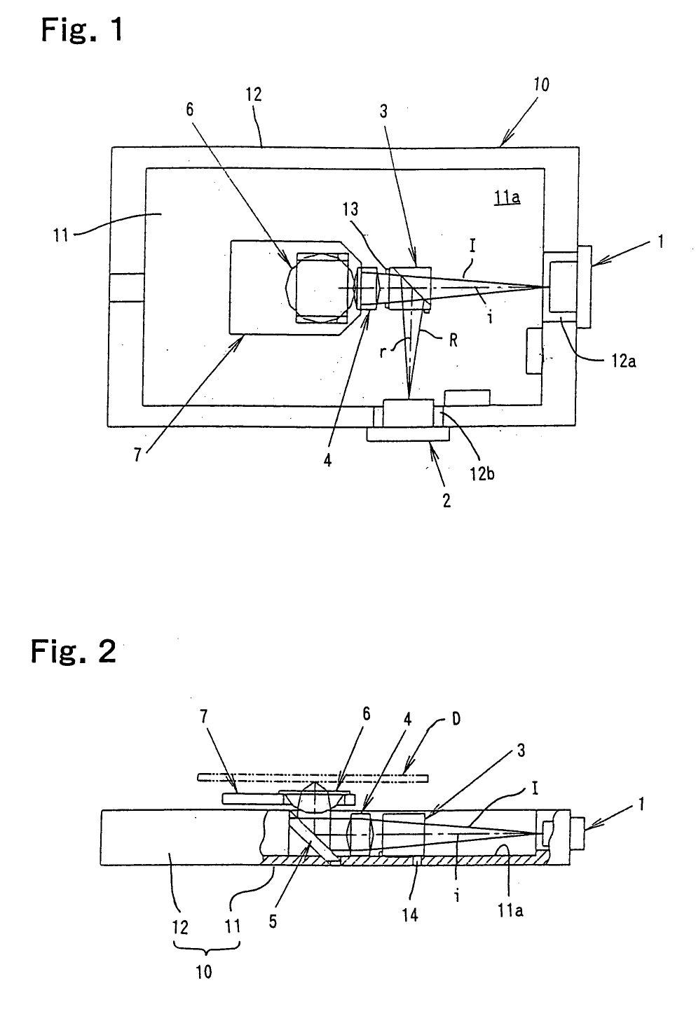

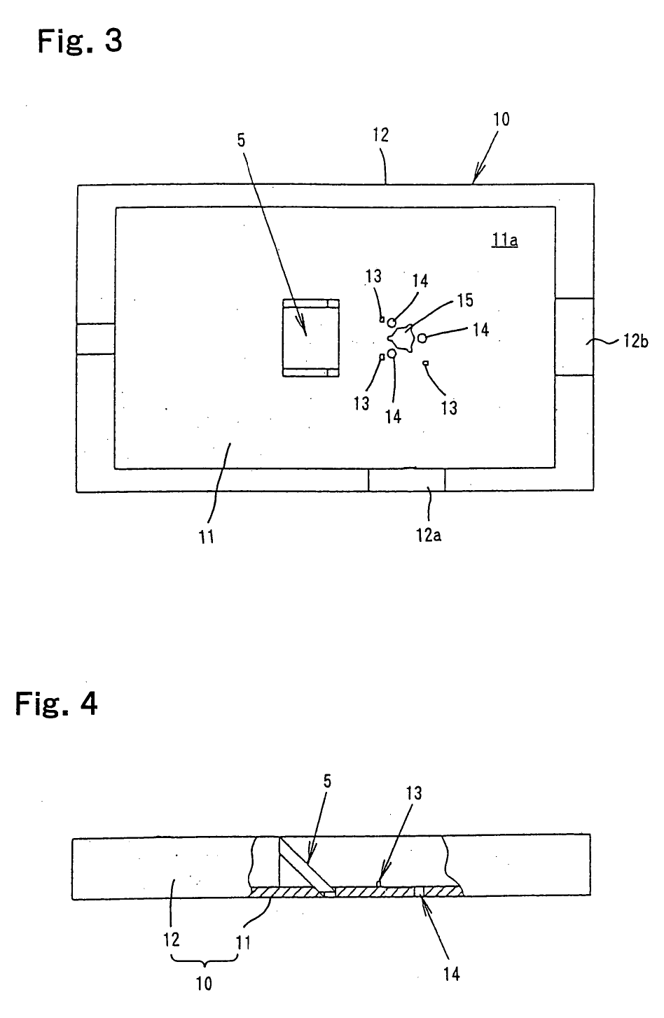

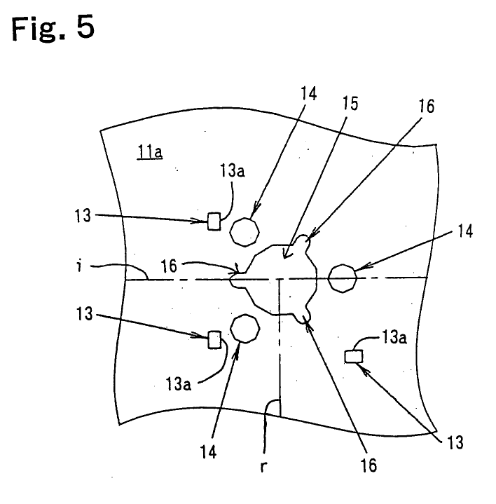

FIG. 1 is a plan view showing an optical pickup device of a first embodiment of the invention. FIG. 2 is a partially sectional side view showing the optical pickup device of the first embodiment. FIG. 3 is a plan view of a housing in the first embodiment. FIG. 4 is a partially cross sectional side view showing the housing in the first embodiment. FIG. 5 is an enlarged plan view of a main portion showing a beam splitter attachment position in the housing in the first embodiment. In FIGS. 1 and 2, alternate long and short dash lines express design optical axes “i” and “r” of laser beams I and R in designing. In FIG. 2, an alternate long and two short dashes line indicates an optical disk D.

The optical pickup device of the first embodiment has a housing 10, laser beam sources 1 and 2 attached in predetermined attaching positions in an optical part attachment surface 11a of the housing 10, a beam splitter 3, a collimator lens 4, a diffraction mirror 5, and an objective lens 6 held by a lens holder 7. In this case, an infrared laser is used for the laser beam source 1, and a red laser is used for the laser beam source 2.

The housing 10 is constructed by a rectangular-shaped bottom wall 11 and a peripheral wall 12 upright along the periphery of the bottom wall 11. The housing 10 has an open shallow box shape. In a short side and a long side forming a right angle of the peripheral wall 12, recesses 12a and 12b notched downward from the upper periphery are formed. The laser beam sources 1 and 2 are attached to the notched recesses 12a and 12b, respectively.

In the optical part attachment surface 11a of the housing 10, in a beam splitter attachment position having a cross point of the design optical axes i and r of the laser beams I and R as an almost center, three temporary positioning projections 13 with which the beam splitter 3 comes into contact so as to be positioned, three through holes 14 in which three projection sticks are inserted to be described later, and an adhesive housing recess 15 for housing the adhesive for adhering the beam splitter 3 onto the optical part attachment surface 11a of the housing 10 are provided.

Two temporary positioning projections 13 out of the three temporary positioning projections 13 are disposed linear symmetrically while their contact surfaces 13a face in the direction orthogonal to the design optical axis i of the laser beam I, and the remaining temporary positioning projection 13 is disposed so that its contact surface 13a faces in a direction orthogonal to the design optical axis “r” of the laser beam R and is disposed on the side opposite to the other temporary positioning projections 13 over the design optical axis “r”. Two neighboring side surfaces of the beam splitter 3 of a cube shape come into contact with the contact surfaces 13a of the three temporary positioning projections 13, thereby enabling the beam splitter 3 to be temporarily positioned in the predetermined position in the optical part attachment surface 11a of the housing 10.

The adhesive housing recess 15 is a recess of a polygonal shape formed in an almost center of the beam splitter attachment position, and three small reserve recesses 16 are formed so as to be communicated with the adhesive housing recess 15 at almost equal pitches in the circumferential direction at the corners in the periphery. In the adhesive housing recess 15, an adhesive S for adhering the beam splitter 3 to the housing 10 is applied. The uncured adhesive S overflowed from the adhesive housing recess 15 when the beam splitter 3 is pressed on the adhesive S is received by the reserve recesses 16.

The three through holes 14 are disposed around the adhesive housing recess 15 in positions at vertexes of an almost equilateral triangle, more specifically, at almost equal pitches in the circumferential direction between the reserve recesses 16. In this case, one reserve recess 16 and one through hole 14 are disposed on the design optical axis i, and two reserve recesses 16 and two through holes 14 are disposed on both sides of the design optical axis i.

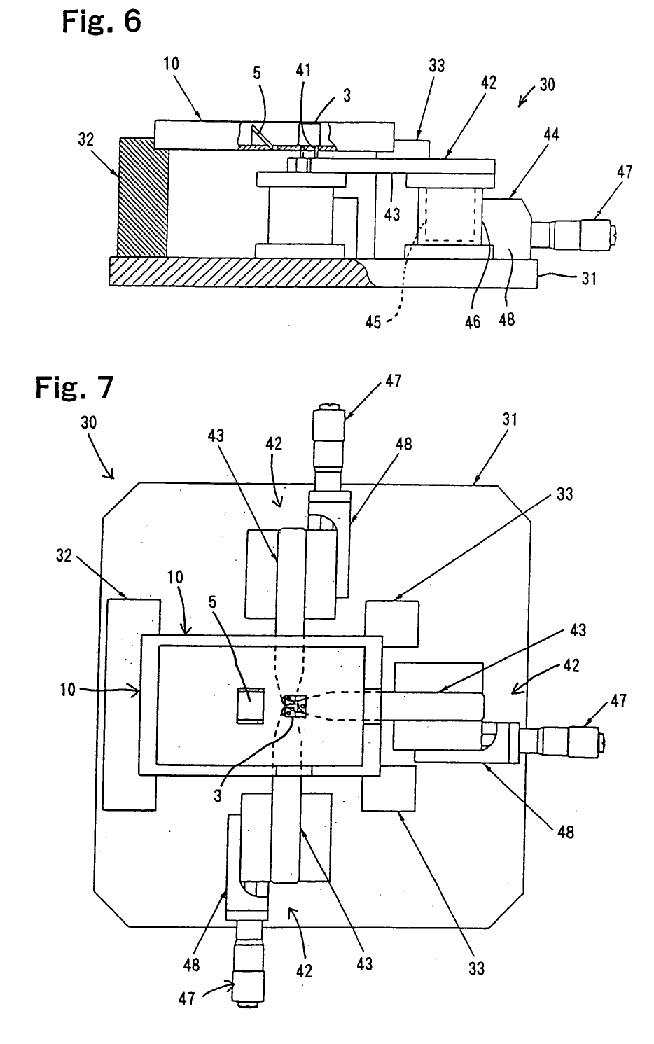

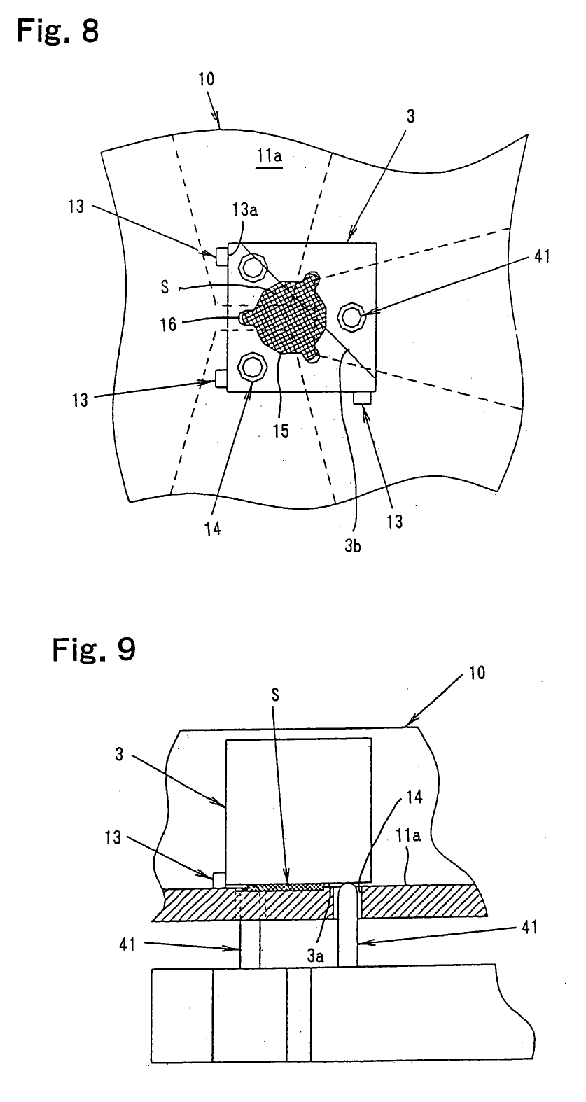

An apparatus for assembling the optical pickup device of the invention will now be described with reference to FIGS. 6 to 9. FIG. 6 is a side view showing the body of the apparatus for assembling the optical pickup device in the first embodiment and shows a state where the beam splitter is being attached to the housing. FIG. 7 is a plan view showing the body of the apparatus for assembling the optical pickup device in the first embodiment and shows a state where the beam splitter is being attached to the housing. FIG. 8 is a plan view of a main portion showing a state where the beam splitter is pressed against the adhesive in the first embodiment. FIG. 9 is a partially cross sectional side view of a main portion showing a state where the angle of an attachment surface of the beam splitter is being adjusted by projection sticks of the assembling apparatus in the first embodiment.

The optical pickup device assembling apparatus has an apparatus body 30 in which a supporting part for supporting the housing 10 and a beam splitter angle adjusting part for adjusting the angle of the attachment surface of the beam splitter 3 in a state where an adhesive is uncured are integrated.

Concretely, the apparatus body 30 has a base 31, a supporting wall 32 upright on the base 31, for supporting corner portions of one of a pair of short sides of the housing 10, and a pair of supports 33, 33 for supporting the corner portions of the other short side of the housing 10. The supporting part is constructed by the supporting wall 32 and the pair of supports 33 and 33.

The beam splitter angle adjustment part has three projection sticks 41 inserted in the three through holes 14 in the housing 10 and whose tops to be in contact with an attachment surface 3a of the beam splitter 3 are rounded, and three vertical small-movement units 42 for independently slightly moving the projection sticks 41 in the vertical direction. The vertical small-movement unit 42 has a horizontal arm portion 43 extending below the housing 10 supported by the supporting part and holding the projection sticks 41 vertically by its end, and a vertical small movement mechanism unit 44 for moving the horizontal arm portion 43 in the vertical direction while supporting the horizontal arm portion 43. The vertical small movement mechanism unit 44 has an inner support 45 provided at a base end of the horizontal arm portion 43, a cylindrical outer guide support 46 for holding the inner support 45 so as to be movable in the vertical direction, an adjusting knob 47, a holding part 48 for rotatably holding the adjusting knob 47, a pinion member not shown fixed at an inner end of the adjusting knob 46 penetrating the side wall of the outer guide support 45 and disposed on the inside, and a rack member not shown provided on the side surface of the inner support 45 along its longitudinal direction which meshes with the pinion member. By turning the adjusting knob 47, the inner support 45 and the horizontal arm portion 43 are moved slightly in the vertical direction so that the projection sticks 41 are slightly moved in the vertical direction.

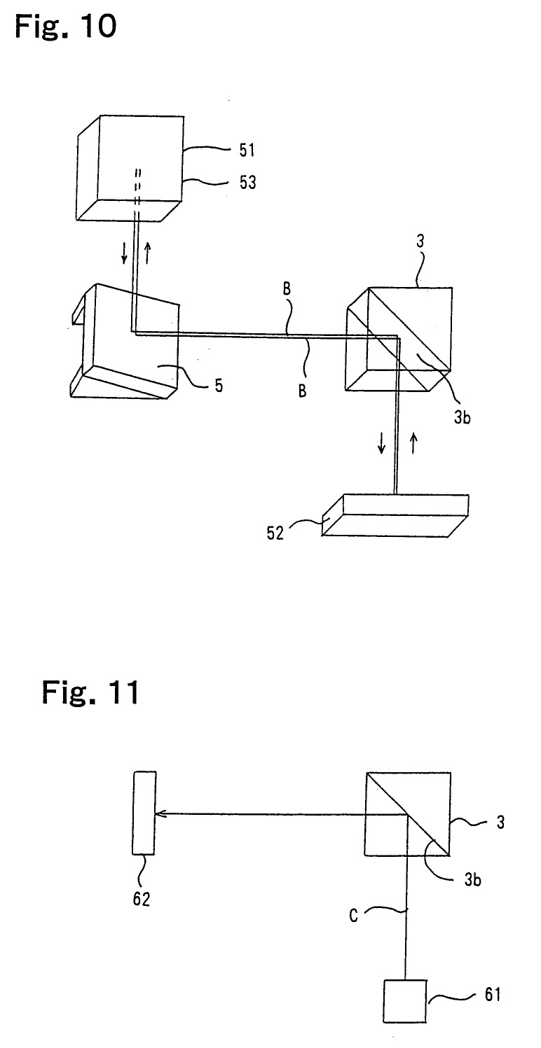

Further, as shown in FIG. 10, the optical pickup device assembling apparatus further comprises, a projector 51 for projecting light to the diffraction mirror 5, a reflection mirror 52 for reflecting light B projected from the projector 51, diffracted by the diffraction mirror 5, incident on the beam splitter 5 in a temporarily positioned state, and reflected by a reflection surface of the beam splitter 3 toward the beam splitter 3; and a backlight detector 53 which is provided integrally with the projector 51 for detecting backlight B₁ transmitted from the reflection mirror 52 via the beam splitter 3 and the diffraction mirror 5. The apparatus can be used for mounting the beam splitter 3 to the housing 10 to which the diffraction mirror 5 is mounted in advance. As a device in which the projector 51 and the backlight detector 53 are integrated, for example, an auto collimator is used.

An assembling method in the case of attaching the beam splitter 3 to the housing 10 to which the diffraction mirror 5 is preliminarily attached by using the assembling apparatus will now be described with reference to FIGS. 6 to 10.

S1: First, the housing 10 is installed on the apparatus body 30, thereby inserting the upper ends of the three projection sticks 41 into the three through holes 14 in the housing 10. At this time, the projection sticks 41 are re-set in the initial positions so that the upper ends of the projection sticks 41 come into contact with the attachment facing surface (undersurface) 3a of the beam splitter 3.

S2: In process (A), a predetermined amount of the adhesive S is applied to the adhesive housing recess 15 in the optical parts attachment surface 11a of the housing 10. As the adhesive S, a photo-curing adhesive is used.

S3: In process (B); while pressing the beam splitter 3 on the adhesive S, the beam splitter 3 is set in a temporary positioned state in which two side surfaces of the beam splitter 3 are in contact with the contact surfaces 13a of the three temporary positioning projections 13. At this time, the adhesive S is spread in the adhesive housing recess 15 by being pressed by the beam splitter 3 and the excessive adhesive S flows in the three reserve recesses 16.

S4: In process (C1), the integrated projector 51 and backlight detector 53 (light receiving unit, light emitting unit, and optical part units) are disposed in predetermined positions above the diffraction mirror 5. The reflection mirror 52 is disposed in a predetermined position on a side of the beam splitter 3. After that, the laser beam B is projected from the projector 51 to the diffraction mirror 5. The laser beam B is reflected by the diffraction mirror 5, and the reflected beam B is incident on the beam splitter 3 and reflected by the reflection surface 3b. The reflection light B is incident on the reflection mirror 52. The backlight B₁ reflected from the reflection mirror 52 is reflected by the beam splitter 3, reflected by the diffraction mirror 5, and incident on the backlight detector 53. The backlight B₁ is detected by the backlight detector 53 and an image of the light is displayed on a CRT monitor. While seeing an image on the CRT monitor, the user turns the adjusting knob 47 of the arbitrary vertical small-movement unit 42 to slightly move the projection sticks 41 in the vertical direction so as to be close/apart to/from the attachment surface 3a of the beam splitter 3. By finely adjusting the angle (inclination) of the attachment surface 3a in such a manner, the beam splitter optical axis is made coincide with the design optical axes i and r (refer to FIG. 1). Specifically, on the CRT monitor, the design optical axes i and r and the actual beam splitter optical axis are displayed. The vertical small-movement units 42 are operated to slightly move the beam splitter 3 so as to make the beam splitter optical axis matches the design optical axes i and r. Since the apex of each of the projection sticks 41 to come into contact with the attachment surface 3a of the beam splitter 3 has a rounded shape, the beam splitter 3 can be smoothly slightly moved at high precision.

S5: When it is determined that the beam splitter optical axis coincides with the design optical axes i and r, the adhesive S is irradiated with an ultraviolet ray by a UV irradiator from above the beam splitter 3 in such a state, thereby promptly curing the adhesive S.

S6: The housing 10 is taken from the apparatus body 30.

According to the invention, the splitter optical axis angle of the beam splitter 3 in the swing direction parallel to the optical part attachment surface 11a of the housing 10 can be held at high precision (within ±5 arcminutes) with respect to the target design optical axes i and r by the three temporary positioning projections 13, and the splitter optical axis angle of the beam splitter 3 in the swing direction toward/apart from the optical parts attachment surface 11a of the housing 10 can be held with high precision (±5 arcminutes) with respect to the target design optical axes i and r by the beam splitter angle adjusting means. Thus, the beam splitter can be fixed in the position by the adhesive and the high-precision optical pickup device can be obtained.

Second Embodiment

In the foregoing first embodiment (FIGS. 3, 4, and 10), the case of attaching the beam splitter 3 to the housing 10 by performing position adjustment, in which the diffraction mirror 5 is preliminarily attached has been described. In a second embodiment, as shown in FIG. 11, the beam splitter 3 is mounted on the housing 10 by performing position adjustment before the diffraction mirror is attached.

An optical pickup device assembling apparatus in the second embodiment has a supporting part and a beam splitter angle adjusting part similar to those in the first embodiment (refer to FIGS. 6 and 7). The apparatus further includes a projector 61 for projecting light to the beam splitter 3 installed in the housing via an adhesive in a temporarily positioned state, and a reflection light detector 62 for detecting light C transmitted from the projector 61 and reflected by the reflection surface 3b of the beam splitter 3. As the projector 61, the same semiconductor laser as that used in the optical pickup device is employed. As the reflection light detector 62, a CCD camera is used so that an image can be seen on a CRT monitor.

A method of assembling an optical pickup device by using the assembling apparatus of the second embodiment has the same steps as those of the assembling method of the foregoing first embodiment except for step S4. Step S4-1 replacing step S4 is as follows.

S4-1: In process (C2), the projector 61 is disposed in a predetermined position on a side of the beam splitter 3, and the reflection light detector 62 is disposed in a predetermined position rearward of the beam splitter 3 (for example, near the diffraction mirror attachment position). After that, light is emitted from the projector 61 to the beam splitter 3. A laser beam C is reflected by the reflection surface 3b of the beam splitter 3 and the reflected light C is incident on the reflection light detector 62. The reflected light C is detected by the reflection light detector 62 and an image is displayed on the CRT monitor. While seeing the image on the CRT monitor, the user operates the angle adjusting part for the beam splitter to finely move the beam splitter 3 so that the beam splitter optical axis matches the design optical axis.

In the second embodiment as well, in a manner similar to the first embodiment, the high-precision optical pickup device can be obtained.

Third Embodiment

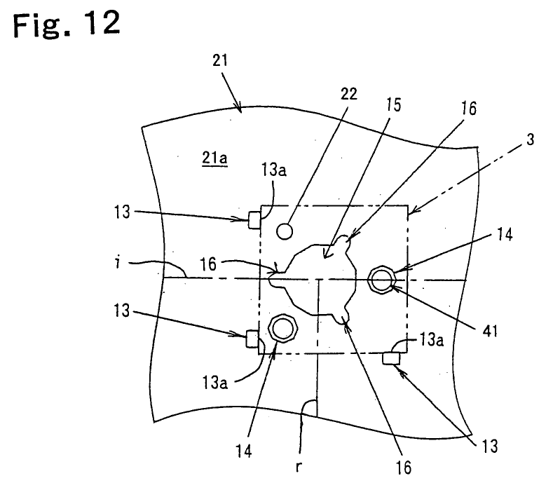

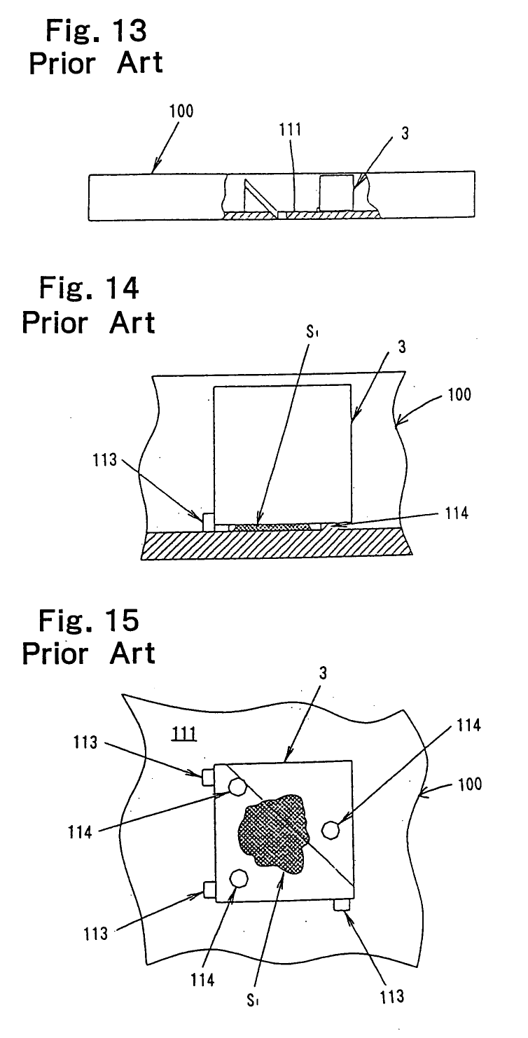

FIG. 12 is a plan view showing a state where the beam splitter is temporarily positioned in the housing of the optical pickup device in a third embodiment.

In the third embodiment, in a housing 21, two through holes 14 are formed in two positions out of three vertexes of an almost equilateral triangle around the adhesive housing recess 15 in the beam splitter attachment position (optical parts attachment surface 21a), and a projection 22 for supporting the attachment surface (undersurface) of the beam splitter 3 is provided in the position of the remaining vertex of the almost equilateral triangle. In the third embodiment, elements similar to those in the first and second embodiments are designated by the same reference numerals.

In the third embodiment, the beam splitter 3 is temporarily positioned in the beam splitter attachment position of the housing 21. At the time of positional adjustment, adjustment is performed so that the splitter optical axis matches the design optical axis by slightly moving the two projection sticks 41 and 41 in the vertical direction while supporting the undersurface of the beam splitter 3 by the projection 22 and the two projection sticks 41 and 41. In this case, the height of the projection 22 from the optical parts attachment surface 21a of the housing 21 is set to an almost the height of the projection stick 41 from the optical parts attachment surface 21a. The tip of the projection 22 is preferably formed to have an acute angle or a rounded shape so as to come into point-contact with the undersurface of the beam splitter 3.

With the configuration, one projection stick of the assembling apparatus and the mechanism for slightly moving the one projection stick can be omitted, so that an advantage that the structure of the assembling apparatus can be simplified is obtained.

Other Embodiments

1. In the foregoing embodiments, the case of disposing the three temporary positioning projections so that two temporary positioning projections come into contact with a side surface of the beam splitter, and the temporary positioning projection comes into contact with another side face adjacent to the side face of the beam splitter has been described. The invention, however, is not limited to the case. Since it is sufficient that the temporary positioning projection comes into contact with neighboring two side surfaces of the beam splitter, for example, one temporary positioning projection having an L shape in plan view which comes into contact with the one side surface and the another side surface may be provided.

2. In the foregoing embodiments, the case of providing three through holes in the housing, inserting the projection sticks in the through holes, and adjusting the angle of the attachment surface of the beam splitter has been described. It is also possible to adjust the angle of the attachment surface by making four projection sticks come into contact with four corner portions in the attachment surface of the beam splitter. For this purpose, four through holes may be formed in the housing. In this case, it is preferable to form four reserve recesses communicated with the adhesive housing recess between the through holes.

According to the invention, at the time of assembling the optical pickup device, in a state where the adhesive is uncured, the projection sticks are individually displaced with respect to the attachment surface of the beam splitter, thereby enabling the space between the beam splitter and the optical parts attachment surface of the housing and the angle of the attachment surface of the beam splitter to be adjusted at high precision. As a result, the optical axis angle of the beam splitter in the swing direction parallel to the optical part attachment surface of the housing can be held at high precision (within ±5 arcminutes) with respect to the design optical axis as a target. Further, the splitter optical axis angle of the beam splitter in the swing direction toward/apart from the optical parts attachment surface of the housing can be held at high precision (within ±5 arcminutes) with respect to the target design optical axis as a target. In the position, the beam splitter can be fixed by the adhesive. Thus, the high-precision optical pickup device can be obtained. The invention can be easily carried out without largely changing an existing optical pickup device manufacturing process.

What is claimed is:

1. An optical pickup device comprises at least:
a housing; and
a beam splitter fixed to a beam splitter attachment position of the housing by an adhesive so that a splitter optical axis matches a design optical axis,
wherein the housing has a temporary positioning projection for temporarily positioning the beam splitter in/around the beam splitter attachment position by abutting the beam splitter, and in the beam splitter attachment position, a plurality of through holes for inserting therein a plurality of projection sticks which are movable toward/apart from an attachment surface of the beam splitter while the beam splitter is abutting the temporarily positioning projection and the adhesive is uncured.

2. The device of claim 1, wherein the housing has, in its beam splitter attachment position, an adhesive housing recess for housing an adhesive and a reserve recess communicated with the adhesive housing recess for receiving an uncured adhesive overflowed from the housing recess by being pressed by the beam splitter.

3. The device of claim 2, wherein the adhesive housing recess is disposed almost in the center of the beam splitter attachment position of the housing, and the through holes are disposed around the adhesive housing recess.

4. The device of claim 1, further comprises a diffraction mirror attached to the housing for reflecting light from the beam splitter.

5. The device of claim 3, wherein the through holes comprise three through holes provided in positions of three vertexes of an almost equilateral triangle around the adhesive housing recess in the beam splitter attachment position of the housing.

6. The device of claim 3, wherein the through holes comprise two through holes provided in positions of two vertexes of an almost equilateral triangle around the adhesive housing recess in the beam splitter attachment position of the housing, and a projection for supporting the attachment surface of the beam splitter is provided in a position of the remaining one vertex of the equilateral triangle.

7. A method of assembling the optical pickup device of claim 1 comprises the steps of:
(A) applying an adhesive to a beam splitter attachment position of a housing;
(B) mounting the beam splitter in a temporarily positioned state at the beam splitter attachment position via the adhesive;
(C1) adjusting an angle of an attachment surface of the beam splitter in a state where the adhesive is uncured,
wherein in the step (C1), the angle of the attachment surface of the beam splitter is adjusted so that a beam splitter optical axis matches a design optical axis by inserting projection sticks in through holes formed in the beam splitter attachment position of the housing and moving each of the projection sticks toward/apart from the attachment surface while detecting light projected to the beam splitter and reflected by a reflection surface of the beam splitter.

8. A method of assembling the optical pickup device of claim 4 comprises the steps of:
(A) applying an adhesive to a beam splitter attachment position of a housing;
(B) mounting a beam splitter in a temporary positioned state at the beam splitter attachment position via the adhesive;
(C2) adjusting an angle of an attachment surface of the beam splitter in a state where the adhesive is uncured,
wherein in the step (C2), the angle of the attachment surface of the beam splitter is adjusted so that a beam splitter optical axis matches a design optical axis by inserting projection sticks in through holes formed in the beam splitter attachment position of the housing and moving each of the projection sticks toward/apart from the attachment surface while allowing light projected to and reflected from a diffraction mirror to enter the beam splitter, allowing the light reflected by a reflection surface of the beam splitter to be emitted to a reflection mirror, allowing backlight reflected by the reflection mirror to be reflected by the beam splitter, allowing the light reflected by the beam splitter to be reflected by the diffraction mirror and detecting the light reflected by the diffraction mirror.

9. An apparatus for assembling the optical pickup device of claim 1 comprises:
a supporting part for supporting a housing;
a projector for projecting light to a beam splitter which is mounted in a temporary positioned state at a beam splitter attachment position of the housing via an adhesive;
a reflected light detector for detecting light projected from the projector and reflected by a reflection surface of the beam splitter; and
a beam splitter angle adjusting unit for adjusting the angle of an attachment surface of the beam splitter in a state where the adhesive is uncured,
wherein the beam splitter angle adjusting unit has projection sticks inserted in through holes formed in the beam splitter attachment position of the housing and move toward/apart from the attachment surface of the beam splitter, for adjusting the angle of the attachment surface so that a beam splitter optical axis matches a design optical axis.

10. An apparatus for assembling the optical pickup device of claim 4 comprises:
a supporting unit for supporting a housing;
a projector for projecting light via a diffraction mirror to a beam splitter mounted in a temporary positioned state at a beam splitter attachment position of the housing via an adhesive;
a reflection mirror for reflecting toward the beam splitter light projected from the projector, diffracted by the diffraction mirror, incident on the beam splitter and reflected by a reflection surface of the beam splitter;
a backlight detector provided integrally with the projector for detecting backlight transmitted from the reflection mirror via the beam splitter and the diffraction mirror; and
a beam splitter angle adjusting unit for adjusting the angle of an attachment surface of the beam splitter in a state where the adhesive is uncured,
wherein the beam splitter angle adjusting unit has projection sticks inserted in through holes formed in the beam splitter attachment position of the housing and move toward/apart from the attachment surface of the beam splitter, for adjusting the angle of the attachment surface so that a beam splitter optical axis matches a design optical axis.

11. The apparatus of claim 9, wherein the projection sticks each has a rounded apex that abuts the attachment surface of the beam splitter.
